(19) United States
(12) Patent Application Publication
(10) Pub. No.: US 2026/0156116 A1
(43) Pub. Date: Jun. 4, 2026

(54) AUDITING ACCESS CONTROL LISTS OF A NETWORK INFRASTRUCTURE

(71) Applicant: Google LLC, Mountain View, CA (US)

(72) Inventors: Meenakshy Balachandran, San Jose, CA (US); Joseph A. Reid, IV, Fairport, NY (US); Patrick Robert Nehls, Sunnyvale, CA (US)

(21) Appl. No.: 18/967,941

(22) Filed: Dec. 4, 2024

(51) Int. Cl. H04L 9/40

(52) U.S. Cl. CPC H04L 63/101

(57) ABSTRACT

Systems and methods for auditing access control lists (ACLs) of a network infrastructure are provided. A plurality of network interfaces associated with a specified entity is identified. A plurality of access control lists (ACLs) is received. Each ACL of the plurality of ACL includes a plurality of rules associated with a respective network interface of the plurality of network interfaces. Network traffic metadata associated with the plurality of network interfaces is received. A corresponding set of rule utilization parameters is identified for each rule of the plurality of rules by matching the network traffic metadata to the plurality of rules.

### TECHNICAL FIELD

Aspects and implementations of the present disclosure relate to auditing access control lists (ACLs) of a network infrastructure.

### BACKGROUND

Network infrastructure comprises a diverse array of devices, including routers, switches, firewalls, and servers, that collectively provide essential services and connectivity. ACLs play a critical role in enforcing rules, controlling traffic flow, and enhancing network performance and security by granting access based on specific authorization levels.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for auditing access control lists (ACLs) of a network infrastructure. A plurality of network interfaces associated with a specified entity is identified. A plurality of access control lists (ACLs) is received. Each ACL of the plurality of ACL includes a plurality of rules associated with a respective network interface of the plurality of network interfaces. Network traffic metadata associated with the plurality of network interfaces is received. A corresponding set of rule utilization parameters is determined for each rule of the plurality of rules by matching the network traffic metadata to the plurality of rules.

In some implementations, a rule of the plurality of rules specifies at least one of: a source network address, a source port, a destination network address, a destination port, or a protocol.

In some implementations, the network traffic metadata comprise a plurality of network traffic metadata items, each network traffic metadata item specifying at least one of: a source network address of a network packet traversing a specified network interface of the plurality of network interfaces, a source port of the network packet, a destination network address of the network packet, a destination port of the network packet, or a protocol of the network packet.

In some implementations, each rule utilization parameter of the set of rule utilization parameters reflects a number of instances of matching a network traffic metadata item to the rule.

In some implementations, at least one unused rule is identified based on a plurality of sets of rule utilization parameters associated with the plurality of rules.

In some implementations, at least one over-scoped rule is identified based on a plurality of sets of rule utilization parameters associated with the plurality of rules.

In some implementations, at least one unexpected network flow is identified based on a plurality of sets of rule utilization parameters associated with the plurality of rules.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates an example audit tool, in accordance with implementations of the present disclosure.

FIG. 3 depicts a flow diagram illustrating an example method for auditing access control lists (ACLs) of a network infrastructure, in accordance with implementations of the present disclosure.

FIG. 4 is a block diagram illustrating an exemplary computer system, in accordance with implementations of the present disclosure.

### DETAILED DESCRIPTION

Aspects of the present disclosure relate to auditing access control lists (ACLs) of a network infrastructure. A network infrastructure can include a vast array of network devices that work together to provide various services and products. Network devices, such as routers and switches, manage data flows across their multiple network interfaces. A network interface on a network device refers to a physical or virtual point of connection where data enters or exits the network device. ACLs are used to enforce security, control traffic flow, enhance network performance, and provide valuable data for monitoring and incident response. An ACL can include one or more access control rules (“rules”), such that each rule can specify whether to permit or deny traffic based on IP addresses, protocols, port numbers, or etc.

The ACL can be configured to allow only specific users, devices, and/or applications to access certain network resources based on their respective authorization levels (i.e., according to the principle of least privilege). By adhering to the principle of least privilege, ACLs can help reduce the impact of any security incidents. If a breach occurs, the attacker access is limited thereby preventing exploitation of the network. Similarly, if an insider threat arises (e.g., a malicious party acting from inside the network), their restricted access limits the potential damage they can cause. Thus, ACLs can be specifically configured to protect against overexposure of sensitive network resources, ensuring that only necessary access is granted and minimizing the risk of widespread security breaches.

Network devices may rely on internal memory, such as ternary content-addressable memory (TCAM), to store and process ACLs efficiently. TCAM is a specialized type of high-speed memory that allows for rapid searching and matching of data, which is essential for the fast processing of ACLs. TCAM stores rules in a way that allows multiple comparisons to be made simultaneously. When a data packet arrives, the network device's firmware uses TCAM to quickly determine if the packet matches any of the stored rules. However, despite its speed and efficiency, TCAM can have limited capacity. Each rule consumes space in TCAM, and network devices can only store a finite number of rules. If the number of rules exceed the TCAM capacity, the device might experience performance degradation.

As the number of network devices grows, the complexity of managing and protecting the network increases significantly. Ensuring that ACLs are effective and do not lead to performance issues or security vulnerabilities requires careful planning, ongoing management, and investment in appropriate technologies.

Aspects of the present disclosure address the above and other deficiencies by using an audit tool to compare network traffic metadata collected by various elements of the network infrastructure with ACLs implemented on network devices of the network infrastructure to identify usage metrics for ACLs defined for the network infrastructure. The usage metrics may then be utilized to identify, e.g., over-scoped rules, unused rules, and/or unexpected network flows. Over-scoped rule refers to a rule in which only a portion of a specified range (of addresses, ports, or protocols) is actually matched by the traffic. Unused rules refer to a rule in which the whole specified range (of addresses or ports) is not matched by the traffic. Unexpected traffic means that a particular packet appeared on a particular interface, but should have not been able to reach that interface.

The audit tool identifies various interfaces of network devices of the network infrastructure. For a given interface, the audit tool identifies a set of rules that are relevant to the given interface. In some embodiments, the rules may be grouped into one or more ACLs. In some implementations, the audit tool may query appropriate network configuration and/or administrative tools for the ACL(s) associated with each router within the network infrastructure being analyzed. In some implementations, the audit tool may translate the received ACLs into a vendor-agnostic format or language.

Each rule may specify source address, protocol, port and destination address, protocol, port, as well as action (e.g., ALLOW, DROP, or DENY), to be performed if a packet being inspected matches those values (which can be single values or ranges). The audit tool receives network traffic metadata from the given interface. Each network traffic metadata item can include one or more headers of a network packet (e.g., the data link level header, the network layer header, and the transport level header). Thus, each network traffic metadata item can include a source address (e.g., Internet Protocol (IP) address) of a network packet traversing a specific network interface of a network device, a destination address (e.g., IP address) of the network packet, the source and destination ports of the network packet, the protocol (e.g., layer 4 protocol, such as TCP or UDP) of the network packet, and the network interface traversed by the network packet.

The audit tool compares each network traffic metadata to the set of rules that are relevant to the given interface. The audit tool determines whether there is a match between a given network traffic metadata and a rule of the set of rules. For example, the audit tool can determine whether the source and destination IP address of a network packet, the source and destination port of the network packet, and the protocol of the network packet associated with the respective network traffic metadata match the corresponding values and/or ranges specified by the rule. Based on the outcome of matching the observed network traffic metadata to each access control rule, the audit tool can update the corresponding rule utilization parameters, such as the rule usage counter and/or one or more bitmaps indicating matched values within an address range, a port range, or protocol specified by the rule.

In some implementations, the audit tool can maintain, in its memory, a usage counter for each access control rule. The usage counter reflects the number of packets matching the rule. The usage counter can facilitate detection of unused rules: a rule having zero usage counter (in other words, no matching packets were detected) after processing a predefined amount of network traffic metadata (e.g., the network traffic metadata covering a predefined period of time) can be declared an unused rule. Accordingly, if the observed network traffic metadata item matches the values and/or ranges specified by a rule, the audit tool can increment the usage counter associated with the rule.

In some implementations, the audit tool can maintain, in its memory, a range coverage map (e.g., a bitmap) for each address range, port range, or protocol specified by each access control rule. In an illustrative example, if the given network traffic metadata matches a rule, the audit tool can set, in the range coverage map(s) associated with the rule, the bit(s) corresponding to the address and/or port value(s) that match the corresponding address and/or port range(s) specified by the rule. The range coverage maps can facilitate detection of over-scoped rules: if only a portion of a range was matched by the observed traffic after processing a predefined amount of network traffic metadata (e.g., the network traffic metadata covering a predefined period of time), the corresponding range can be declared an over-scoped range. A rule having one or more over-scoped ranges can be declared an over-scoped rule.

In some implementations, the audit tool can detect unexpected traffic. In an illustrative example, if the audit tool identifies, on a given interface, a network packet which should have been dropped by applying to pertinent rule(s), the audit tool designates the network traffic metadata as unexpected traffic.

In some implementations, audit tool may process the network traffic metadata in batch mode, asynchronously with respect to observing the actual network traffic. In some implementations, the audit tool may split the network traffic metadata into two or more categories (e.g., IPv4 traffic and IPv6 traffic) and process the metadata of each categories by one or more dedicated processing threads, which may run in parallel with other processing threads, thus enabling scaled ongoing usage evaluations.

Accordingly, aspects of the present disclosure cover techniques that provide in-depth analysis of the ACLs on network devices of the network infrastructure without causing additional processing overhead, thereby providing the administrator of the network infrastructure information to reduce overexposure and improve performance.

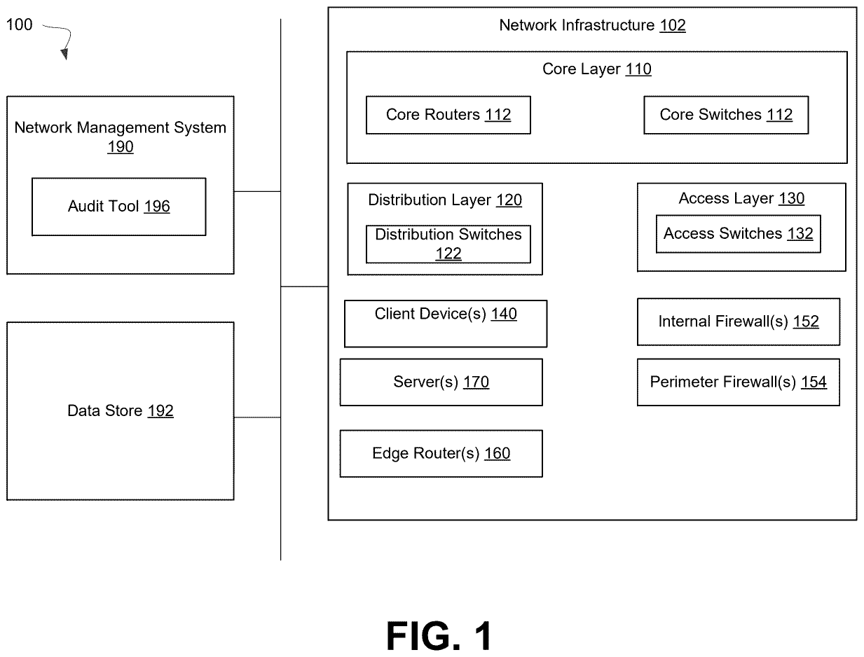

FIG. 1 illustrates an example system architecture 100, in accordance with implementations of the present disclosure. The system architecture 100 (also referred to as “system” herein) includes a network infrastructure 102 and a network management system 190.

The network infrastructure 102 is configured in a hierarchical manner consisting of a core layer 110, a distribution layer 120, and an access layer 130. The core layer 110 can include interconnected core routers 112 and core switches 114. Core routers 112 handle large amounts of data traffic within the core layer 110, providing fast and reliable data routing between other components of the network infrastructure 102. Core switches 114 connect core routers 112 and other key components of the network infrastructure 102. Essentially, the core layer 110 forms the backbone of the network infrastructure 102, facilitating high-speed, high-volume data transport across different segments and ensuring efficient data flow.

The distribution layer 120 connects to the core layer 110 and includes distribution switches 122 that aggregate data traffic from access switches 132 of the access layer 130. Distribution switches 122 manage data routing within the network infrastructure 102. The distribution layer 120 efficiently routes data between the core layer 110 and access layer 130, managing network traffic.

The access layer 130 connects, via access switches 132, client devices 140 to the network infrastructure 102. Client devices 140 include personal computers (PCs), laptops, mobile phones, smartphones, tablet computers, netbook computers, and network-connected televisions. In some implementations, client devices 140 can also be referred to as “user devices.” The access layer 130 facilitates the connection of client devices 140 to the network infrastructure 102, providing access to resources and services via access switches 132.

Internal firewalls 152 are used within each layer to segment different zones and protect sensitive areas. For example, internal firewalls 152 in the core layer 110 protect critical infrastructure components, while in the distribution layer 120 and access layer 130, they help manage and secure traffic between different VLANs and end-user devices.

Servers 170 provide essential applications, resources (e.g., data storage), and services to users. Servers 170 provide the computational and storage resources necessary for network services and include application servers, file servers, database servers, and web servers. Application servers host and run applications. File servers store and manage access to files. Database servers manage and store database services. Web servers serve web pages and handle web traffic.

Edge routers 160 are positioned at the boundary of the network infrastructure 102 and serve as the gateway between the network infrastructure 102 and internet service providers (ISPs) 180. Perimeter firewalls 154, which are positioned between the edge routers 160 and the network infrastructure 102, monitor and control incoming and outgoing traffic, protecting against unauthorized access and external threats. Perimeter firewalls 154 enforces rules, inspect traffic for malicious activity, and provide a barrier that safeguards the network infrastructure 102.

The network management system 190 is a platform for creating, managing, and enforcing rules on the network infrastructure 102. It allows network administrators to define access control rules and distribute them efficiently to various network devices, such as routers, switches, and firewalls. Access control rules consist of various mechanisms to enforce rules, one of which is ACLs. In some implementations, the access control rules (e.g., ACLs) may be stored in data store 192. In some implementations, data store 192 is a persistent storage that is capable of storing data as well as data structures to tag, organize, and index the data. Data store 192 can be hosted by one or more storage devices, such as main memory, magnetic or optical storage-based disks, tapes or hard drives, NAS, SAN, and so forth. In some implementations, data store 192 can be a network-attached file server, while in other implementations data store 192 can be some other type of persistent storage such as an object-oriented database, a relational database, and so forth.

ACLs are a primary method used within the network management system 190 to enforce rules and manage access to components of the network infrastructure 102. ACLs are configured at multiple points within the network infrastructure 102 to control which users and client devices 140 can interact with various components of the network infrastructure 102.

The network management system 190 can configure ACLs on core routers 112 to regulate traffic between major components of the network infrastructure 102, ensuring only authorized traffic flows between critical components. It can configure ACLs on distribution switches 122 to manage access within smaller portions of the network infrastructure 102, enforcing departmental rules. The network management system 190 can also configure ACLs on access switches 132 to restrict access at the edge of the network infrastructure 102, directly controlling which client devices 140 can connect to the network and implementing rules close to the user.

Additionally, the network management system 190 can configure ACLs on perimeter firewalls 154 to monitor and control incoming and outgoing traffic, preventing unauthorized access, and protecting against external threats. The network management system 190 can configure ACLs on internal firewalls 152 to ensure that only authorized users and client devices 140 can access sensitive areas.

The network management system 190 may further include an audit tool 196 configured to ensure that the configuration of ACLs on network devices of the network infrastructure 102 are secure, efficient, and aligned with the rules defined by network administrators of the network infrastructure 102. The audit tool 196 is implemented as a component of the network management system 190, however, audit tool 196 may be implemented by software, firmware, and/or hardware.

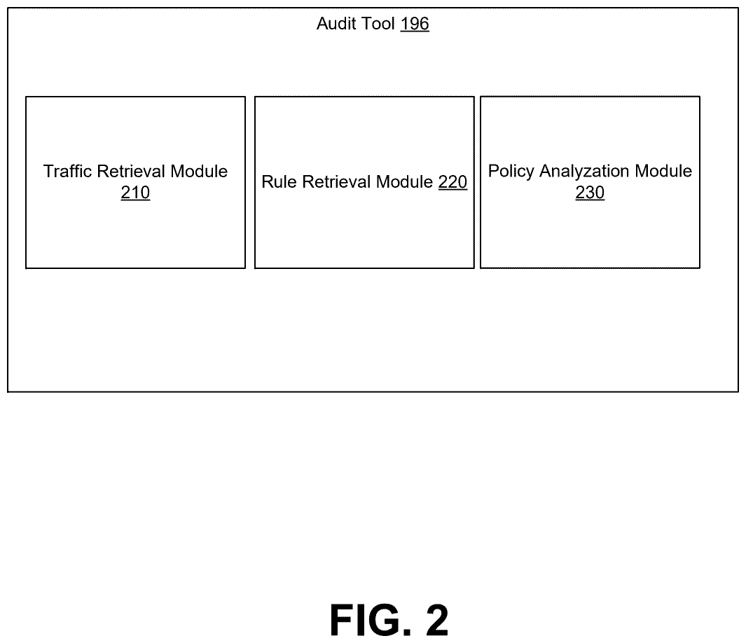

With reference to FIG. 2, a traffic retrieval module 210 of the audit tool 196 obtains a plurality of network traffic metadata from the network infrastructure 102. The network traffic metadata is obtained (using a logging service) from interfaces of the core routers 112, the core switches 114, the distribution switches 122, the access switches 132, the internal firewalls 152, the servers 170, the edge routers 160, and/or the perimeter firewalls 154 (collectively referred to as “network devices of the network infrastructure 102”). As described above, each network traffic metadata of the plurality of network traffic metadata includes a source IP address, a destination IP address, source and destination ports, IP protocol, and an identifier of the network interface of network devices that observed network packet associated with the network traffic metadata (e.g., observed interface identifier). In some implementations, the audit tool 196 obtains the plurality of network traffic metadata for a predetermined window of time (e.g., daily, weekly, monthly).

With reference to FIG. 2, a rule retrieval module 220 of the audit tool 196 may obtain a plurality of ACLs. Each ACL of the plurality of ACLs includes a plurality of rules associated with a network interface of network devices. In some embodiments, the rule retrieval module 220 retrieves, from each network device of the network devices of the network infrastructure 102, a configuration file. The configuration file of each network device defines the operational parameters of the network device. The configuration file of each network device can include, among other things, interface configurations and security configurations. The network interface configurations specify the settings for each network interface on the network device, such as IP addresses. The security configurations consist of an ACL and its rules enforced on a specific interface of the respective network device. Accordingly, the rule retrieval module 220 obtains, using the security configurations of the configuration file for each network device of the network devices of the network infrastructure 102, an ACL including its corresponding plurality of rules. In some embodiments, syntax of the plurality of rules may vary. Thus, the rule retrieval module 220 may utilize rules from a repository matching the plurality of rules obtained from the configuration files of the network devices of the network infrastructure 102. The repository includes a plurality of rules defined by the administrator of the network infrastructure 102 using a uniform syntax.

With continued reference to FIG. 2, a policy analyzation module 230 of the audit tool 196 compares each network traffic metadata of the plurality of network traffic metadata with each rule of the plurality of rules that is relevant to an interface in which the traffic associated with the network traffic metadata appeared on. More specifically, the policy analyzation module 230 determines whether network traffic metadata items (e.g., the source and destination IP address, port, and protocol) of the respective network traffic metadata match (or falls within range of) a respective rule. A rule usage counter associated with the respective rule which represents a numerical value is incremented by one for each instance a network traffic metadata matched the respective rule. Additionally, a range coverage map (e.g., a bitmap) for a range of each network traffic metadata item (e.g., port, protocol, and address) specified by the respective rule is updated to reflect whether a value of each network traffic metadata item of a respective network traffic metadata matched a value of a specified range of the respective rule associated with the network traffic metadata item. More specifically, each bit of the bitmap corresponds to a value in the range specified by the respective rule. If the value of the network traffic metadata item matches a value in the range specified by the respective rule associated with the network traffic metadata item, a corresponding bit in the bitmap is set (e.g., set to a value of “1”) indicating that the network traffic metadata item of at least one respective network traffic metadata matched the value in the range specified by the respective rule associated with the network traffic metadata item. Once processing is completed for a given period of time (e.g., a day), the rule usage counter and the range coverage map for each rule is stored in a separate file. The audit tool 196 repeats processing every period of time (e.g., every day) for the traffic metadata seen in a previous period of time (e.g., previous day).

The policy analyzation module 230 can obtain metrics for the network infrastructure 102 (e.g., rules utilization parameters). Metrics (or a rule utilization parameter) can include, for example, hit counts, port utilization, protocol utilization, or IP address utilization for a rule. To obtain hit counts, the policy analyzation module 230 obtains, from the respective rule, the rule usage counter. In some implementations, the policy analyzation module 230 obtains the usage counter from each rule associated with an ACL and determines a total for the ACL (e.g., an ACL hit count).

To obtain the remaining rule utilization parameters (e.g., port utilization, protocol utilization, or IP address utilization), the policy analyzation module 230 obtains, from the respective rule, the range coverage map associated with a rule utilization parameter (e.g., range coverage map of ports for port utilization, range coverage map of protocols for protocol utilization, and range coverage map of IP addresses for IP utilization).

The policy analyzation module 230 determines, using the range coverage map of a respective rule, a percentage of usage for each range specified by the respective rule. In particular, the policy analyzation module 230, for each range, identifies a ratio of bits in the range coverage map associated with a network traffic metadata item set (e.g., set to a value of 1) to those that are not set (e.g., set to a value of 0). For range associated with a network traffic metadata having at last one percentage of usage that does not exceed a predetermined threshold is deemed to be an over-scoped range. Accordingly, if the respective rule includes more than a predetermined number of over-scoped ranges, the respective rule is deemed to be over-scoped.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

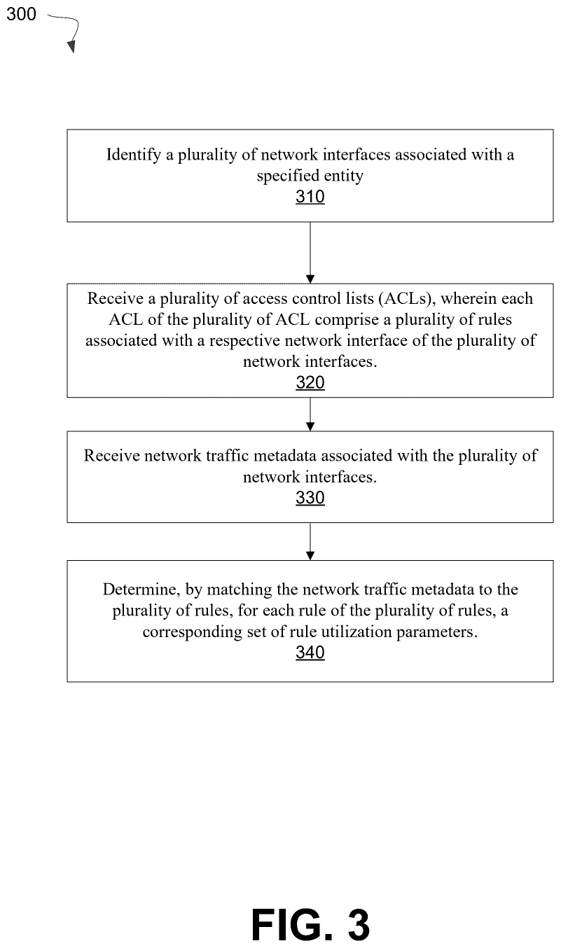

FIG. 3 depicts a flow diagram of a method 300 for auditing access control lists (ACLs) of a network infrastructure, in accordance with implementations of the present disclosure. Method 300 may be performed by processing logic that may include hardware (circuitry, dedicated logic, etc.), software (e.g., instructions run on a processing device), or a combination thereof. In one implementation, some or all the operations of method 300 may be performed by one or more components of system 100 of FIG. 1 (e.g., network management system 190 and/or audit tool 195).

For simplicity of explanation, the method 300 of this disclosure is depicted and described as a series of acts. However, acts in accordance with this disclosure can occur in various orders and/or concurrently, and with other acts not presented and described herein. Furthermore, not all illustrated acts may be required to implement the method 300 in accordance with the disclosed subject matter. In addition, those skilled in the art will understand and appreciate that the method 300 could alternatively be represented as a series of interrelated states via a state diagram or events. Additionally, it should be appreciated that the method 300 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 310, the processing logic identifies, by a processing device, a plurality of network interfaces associated with a specified entity. At block 320, the processing logic receives a plurality of rules. Each rule of the plurality of rules is associated with a respective network interface of the plurality of network interfaces. Each rule of the plurality of rules may specify a source network address, a source port, a destination network address, a destination port, or a protocol. As previously described, a configuration file may be obtained from each network device of the specified entity (network infrastructure) that specifies each rule enforced by the network interface of the respective network device.

At block 330, the processing logic receives network traffic metadata associated with the plurality of network interfaces. The network traffic metadata may include a plurality of network traffic metadata items. The network traffic metadata item can specify a source network address of a network packet traversing a specified network interface of the plurality of network interfaces, a source port of the network packet, a destination network address of the network packet, a destination port of the network packet, or a protocol of the network packet.

At block 340, the processing logic identifies, by matching the network traffic metadata to the plurality of rules, for each rule of the plurality of rules, a corresponding set of rule utilization parameters. Each rule utilization parameter of the set of rule utilization parameters may reflect a number of instances a specific network traffic metadata item matched a rule. The processing logic identifies a corresponding set of rule utilization parameters by associating each network traffic metadata to one or more rules of the plurality of rules. Depending on the embodiment, the processing logic can identify, based on a plurality of sets of rule utilization parameters associated with the plurality of rules, an unused rule, an over-scoped rule, and/or an unexpected network flow.

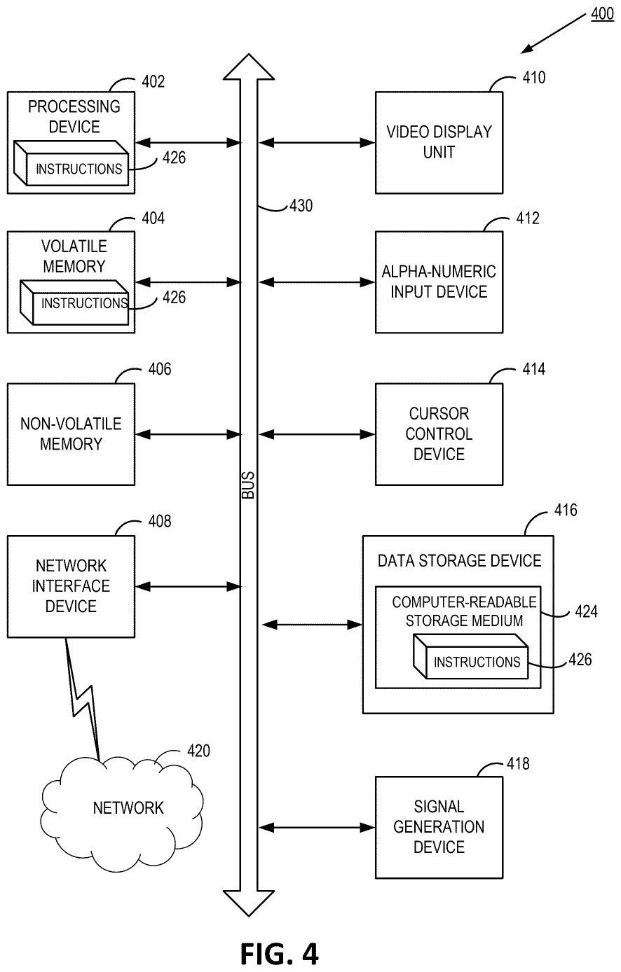

FIG. 4 is a block diagram illustrating an exemplary computer system, in accordance with implementations of the present disclosure. The computer system 400 can be the network management system 190 in FIG. 1. The machine can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 416, which communicate with each other via a bus 430.

Processor (processing device) 402 represents one or more general-purpose processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 426 (e.g., for auditing access control lists (ACLs) of a network infrastructure) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 418 (e.g., a speaker).

The data storage device 416 can include a non-transitory machine-readable storage medium 424 (also computer-readable storage medium) on which is stored one or more sets of instructions 426 (e.g., for auditing access control lists (ACLs) of a network infrastructure) embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 420 via the network interface device 408.

In one implementation, the instructions 426 include instructions for auditing ACLs of a network infrastructure. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
identifying, by a processing device, a plurality of network interfaces associated with a specified entity;
receiving a plurality of access control lists (ACLs), wherein each ACL of the plurality of ACL comprises a plurality of rules associated with a respective network interface of the plurality of network interfaces;
receiving network traffic metadata associated with the plurality of network interfaces; and
determining, by matching the network traffic metadata to the plurality of rules, for each rule of the plurality of rules, a corresponding set of rule utilization parameters.

2. The method of claim 1, wherein a rule of the plurality of rules specifies at least one of: a source network address, a source port, a destination network address, a destination port, or a protocol.

3. The method of claim 1, wherein the network traffic metadata comprises a plurality of network traffic metadata items, each network traffic metadata item specifying at least one of: a source network address of a network packet traversing a specified network interface of the plurality of network interfaces, a source port of the network packet, a destination network address of the network packet, a destination port of the network packet, or a protocol of the network packet.

4. The method of claim 1, wherein a rule utilization parameter of the set of rule utilization parameters is a usage counter associated with the rule.

5. The method of claim 1, wherein a rule utilization parameter of the set of rule utilization parameters is a range coverage map associated with one of: an address range, a port range, or protocol specified by the rule.

6. The method of claim 1, further comprising:
identifying, based on a plurality of sets of rule utilization parameters associated with the plurality of rules, at least one unused rule.

7. The method of claim 1, further comprising:
identifying, based on a plurality of sets of rule utilization parameters associated with the plurality of rules, at least one over-scoped rule.

8. The method of claim 1, further comprising:
identifying, based on a plurality of sets of rule utilization parameters associated with the plurality of rules, at least one unexpected network packet.

9. A system comprising:
a processing device to perform operations comprising:
identifying, by a processing device, a plurality of network interfaces associated with a specified entity;
receiving a plurality of access control lists (ACLs), wherein each ACL of the plurality of ACL comprises a plurality of rules associated with a respective network interface of the plurality of network interfaces;
receiving network traffic metadata associated with the plurality of network interfaces; and
determining, by matching the network traffic metadata to the plurality of rules, for each rule of the plurality of rules, a corresponding set of rule utilization parameters.

10. The system of claim 9, wherein a rule of the plurality of rules specifies at least one of: a source network address, a source port, a destination network address, a destination port, or a protocol.

11. The system of claim 9, wherein the network traffic metadata comprises a plurality of network traffic metadata items, each network traffic metadata item specifying at least one of: a source network address of a network packet traversing a specified network interface of the plurality of network interfaces, a source port of the network packet, a destination network address of the network packet, a destination port of the network packet, or a protocol of the network packet.

12. The system of claim 9, wherein each rule utilization parameter of the set of rule utilization parameters reflects a number of instances of matching a network traffic metadata item to a respective rule.

13. The system of claim 9, wherein the processing device to perform operations further comprising:
identifying, based on a plurality of sets of rule utilization parameters associated with the plurality of rules, at least one unused rule.

14. The system of claim 9, wherein the processing device to perform operations further comprising:
identifying, based on a plurality of sets of rule utilization parameters associated with the plurality of rules, at least one over-scoped rule.

15. The system of claim 9, wherein the processing device to perform operations further comprising:
identifying, based on a plurality of sets of rule utilization parameters associated with the plurality of rules, at least one unexpected network flow.

16. A non-transitory machine-readable storage medium storing instructions which, when executed, cause a processing device to perform operations comprising:
identifying, by the processing device, a plurality of network interfaces associated with a specified entity;
receiving a plurality of access control lists (ACLs), wherein each ACL of the plurality of ACL comprises a plurality of rules associated with a respective network interface of the plurality of network interfaces;
receiving network traffic metadata associated with the plurality of network interfaces; and
determining, by matching the network traffic metadata to the plurality of rules, for each rule of the plurality of rules, a corresponding set of rule utilization parameters.

17. The non-transitory machine-readable storage medium of claim 16, wherein a rule of the plurality of rules specifies at least one of: a source network address, a source port, a destination network address, a destination port, or a protocol.

18. The non-transitory machine-readable storage medium of claim 16, wherein the network traffic metadata comprises a plurality of network traffic metadata items, each network traffic metadata item specifying at least one of: a source network address of a network packet traversing a specified network interface of the plurality of network interfaces, a source port of the network packet, a destination network address of the network packet, a destination port of the network packet, or a protocol of the network packet.

19. The non-transitory machine-readable storage medium of claim 16, wherein the processing device to perform operations further comprising:
identifying, based on a plurality of sets of rule utilization parameters associated with the plurality of rules, at least one unused rule or at least one over-scoped rule.

20. The non-transitory machine-readable storage medium of claim 16, wherein the processing device to perform operations further comprising:
identifying, based on a plurality of sets of rule utilization parameters associated with the plurality of rules, at least one unexpected network flow.
